(19) United States
(12) Patent Application Publication
(10) Pub. No.: US 2003/0037277 A1
(43) Pub. Date: Feb. 20, 2003

(54) Semiconductor device

(75) Inventor: Hiroaki Tamura, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/043,208

(22) Filed: Jan. 14, 2002

(30) Foreign Application Priority Data
Aug. 20, 2001 (JP) 2001-249205

(51) Int. Cl. H04L 1/22

(52) U.S. Cl. 714/5

(57) ABSTRACT

The semiconductor device includes a first chip having an electrically rewritable nonvolatile memory and a second chip having memories including a redundant circuit for repair. The first and second chips are provided on a substrate. Information required for utilizing the redundant circuit in place of a faulty portion in the memories on the second chip is stored in the nonvolatile memory on the first chip. When a faulty portion is detected in the memories on the second chip, the redundant circuit is utilized in place of the faulty portion based on the information stored in the nonvolatile memory.

### FIELD OF THE INVENTION

The present invention relates to a semiconductor device, such as an LSI, capable of repairing a memory by changing over from a faulty portion in a memory to a memory for a redundant circuit which operates normally and omitting a test after performing such a repair.

### BACKGROUND OF THE INVENTION

Conventionally, forming a redundant circuit in addition to and together with a main memory circuit in a semiconductor device is known. Such redundant circuit is formed in order to improve the yield in a fabricating process is known. The redundant circuit can be used in place of a part or entire of the main memory circuit. An operation test (self test) to check whether the main memory circuit is operating normally is conducted during the fabricating process. If the operation test shows that the main memory circuit is defective, a portion in the main memory circuit that is defective is decided by an analysis for repair, and the redundant circuit is utilized in place of this portion. The redundant circuit is utilized in place of the defective portion of the main memory circuit generally as follows. As explained above, the defective portion of the main memory circuit is know from the analysis for repair. Fuses are provided between the redundant circuit and a plurality of portions of the main memory circuit. The fuse(s) corresponding to the defective portion of the main memory circuit are blown using laser beams.

Since such a redundant circuit is formed from beginning, there is a disadvantage that an overall area of the semiconductor device increases, or the packing density increases. However, since the redundant circuit is very effective from the viewpoint of the yield, it can not be eliminated.

Blowing of the fuse mentioned above is performed as follows. That is, the fuse is melted and evaporated using the heat of laser beams. It is however known that when a number of fuses are repeatedly irradiated with laser beams, a damage may be caused to the underlying layer(s) of the fuse. When a semiconductor electric device is formed in a position directly below a fuse, the semiconductor electric device is damaged by the irradiation of the laser beam, and the whole product becomes defective. Consequently, as shown in FIG. 5, a conventional semiconductor device 1 employs the following configuration. Regions of a circuit 2 for a general logic, various memories 3a and 3b including a redundant circuit for improving the yield, and a BIST (Built-In-Self-Test) circuit 4 for a memory test and, in addition, regions of fuses 5 are disposed together. No circuit element is not disposed under the regions of the fuses 5. Even if a fuse is blown using heat, the heat will not case an unnecessary damage because there is no circuit element under the fuses 5.

In the conventional semiconductor device as described above, however, burning of a fuse with a laser beam at the time of replacing a main memory circuit with a redundant circuit is performed in the fabricating process. That is, a defect in the main memory circuit can be repaired only in the state of the wafer, and a failure in the circuit which occurs after the circuit is packaged cannot be addressed, so that the yield is low. The fuse is physical burnt. Consequently, once a fuse is burnt, the state is fixed and there is a case that a defect which occurs later cannot be repaired. Thus, the yield is similarly low. Further, after a defect is repaired by burning a fuse with a laser beam, in order to confirm that a portion which cannot be repaired or an insufficient repaired portion does not exist, screening of a failure to be repaired has to be performed, and a cost for conducting a test for this purpose increases.

Further, when a BIST circuit for a memory test is defective, as shown in FIG. 5, since the BIST circuit 4 for a memory test is mounted together with the general logic circuit 2 and the various memories 3a and 3b on a single chip, the whole semiconductor device 1 constructing the chip is regarded as defective and is discarded. This causes decrease in the yield.

### SUMMARY OF THE INVENTION

It is an object of this invention to obtain a semiconductor device in which a redundant circuit can be utilized in place of a faulty portion of a main memory circuit not only in the wafer process in a fabricating process but also after the device is packaged.

The semiconductor device according to one aspect of the present invention comprises a first chip having an electrically rewritable nonvolatile memory, a second chip including a memory having therein a redundant circuit, and a substrate on which the first chip and second chip are mounted. Information required for utilizing the redundant circuit in place of a faulty portion in the memory on the second chip is stored in the nonvolatile memory on the first chip. The redundant circuit is utilized in place of the faulty portion in the memory on the second chip based on the information stored in the nonvolatile memory. Thus, the redundant circuit is utilized in place of the faulty portion using a software, and there is no mechanical process such as blowing of fuses etc.

The semiconductor device according to another aspect of the present invention comprises a first chip having an electrically rewritable nonvolatile memory, a second chip including a memory, a third chip having a redundant circuit, and a substrate on which the first chip, the second chip, and the third chip are mounted. Information required for utilizing the redundant circuit in place of a faulty portion in the memory on the second chip is stored in the nonvolatile memory on the first chip. The redundant circuit on the third chip is utilized in place of the faulty portion in the memory on the second chip based on the information stored in the nonvolatile memory on the first chip. Thus, the redundant circuit is utilized in place of the faulty portion using a software, and there is no mechanical process such as blowing of fuses etc.

Other objects and features of this invention will become apparent from the following description with reference to the accompanying drawings.

### BRIEF DESCRIPTION OF THE DRAWINGS

FIG. 1A is a schematic diagram showing a conventional semiconductor device, and FIGS. 1B and 1C are schematic diagrams showing a first embodiment of a semiconductor device according to the invention.

FIG. 2A is a schematic diagram showing the conventional semiconductor device, and FIGS. 2B and 2C are schematic diagrams showing a second embodiment of a semiconductor device according to the invention.

FIG. 3A is a schematic diagram showing the conventional semiconductor device, and FIGS. 3B and 3C are schematic diagrams showing a third embodiment of the semiconductor device according to the invention.

FIGS. 4A and 4B are side view and plan view, respectively, showing a fourth embodiment of the semiconductor device according to the invention.

FIG. 5 is a schematic diagram showing a conventional semiconductor device.

### DETAILED DESCRIPTIONS

Embodiments of a semiconductor device according to the invention will be described in detail hereinbelow with reference to the accompanying drawings. In the embodiments of the invention described hereinbelow, the same reference numerals will be used to designate the same components as those of the conventional technique.

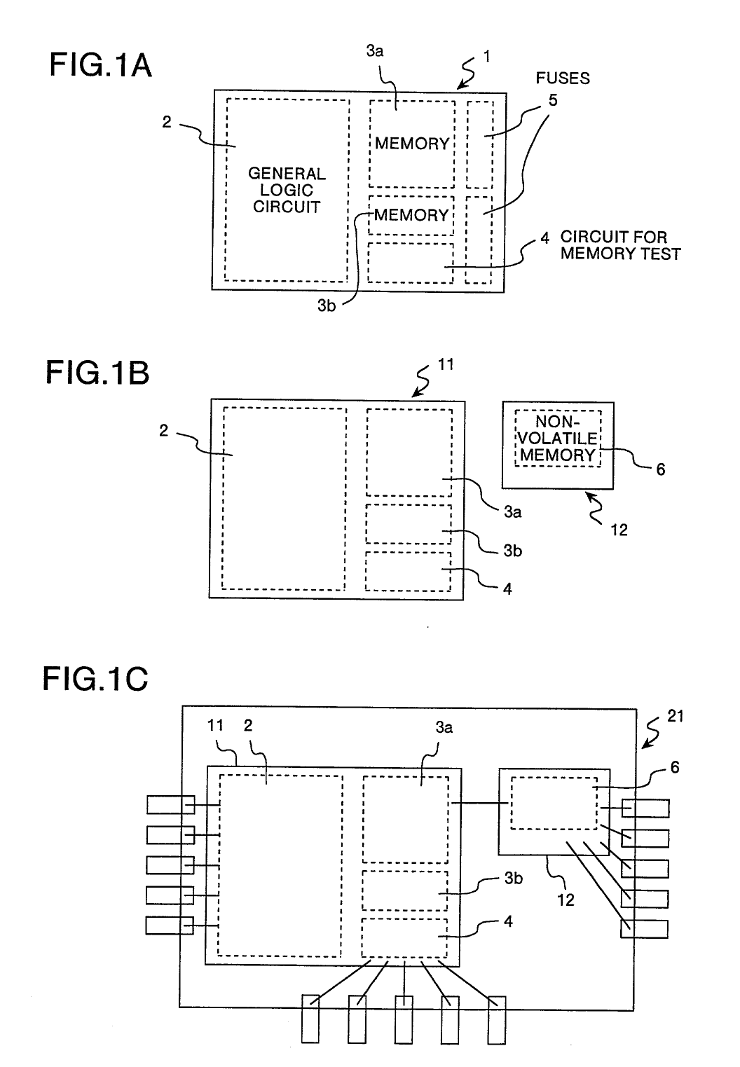

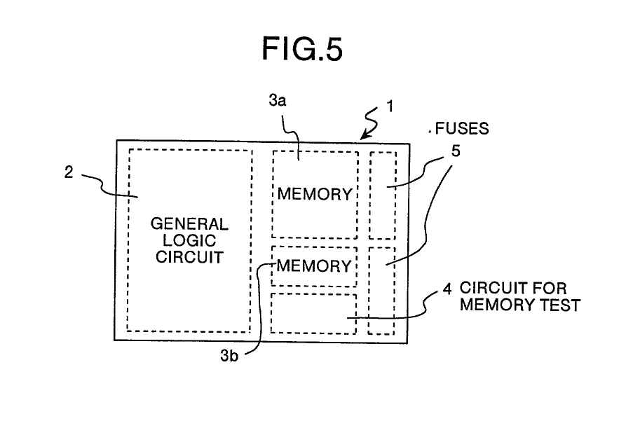

FIG. 1A shows a conventional semiconductor device shown in FIG. 5. The general logic circuit 2, the various memories 3a and 3b, the memory test circuit 4, and the fuses 5 are mounted together on a single chip.

FIGS. 1B and 1C show a first embodiment of a semiconductor device according to the present invention. These figures schematically illustrate the difference in the configuration from that of the conventional semiconductor device. FIG. 1A shows the semiconductor device 1, a circuit 2 for a general logic, various memories 3a and 3b including a redundant circuit for improving the yield, a BIST circuit 4 for a memory test (hereinbelow, called a memory test circuit) for testing the circuit, making repair analysis, and repairing a memory, and fuses 5. FIG. 1B shows an electrically rewritable non-volatile memory 6, and a product LSI chip 11. This LSI chip 11 comprises the general logic circuit 2, memories 3a and 3b, and memory test circuit 4. The electrically rewritable non-volatile memory 6 is mounted on an LSI chip 12 for software repair. FIG. 1C shows a substrate 21 on which the LSI chips 11 and 12 are mounted. The substrate 21 is an insulating substrate on which a plurality of LSI chips are mounted and connected to each other by a method such as bonding of a beam lead method, wire bonding, flip chip bonding, a method using a through hole, or SiP (Silicon in a Package) such as soldering.

In contrast to the conventional semiconductor device shown in FIG. 1A, in the semiconductor device of the first embodiment, as shown in FIG. 1B, the LSI chip 11 on which the fuses 5 have not been provided and the LSI chip 12 for software repair are formed separately from each other. Further, in the semiconductor device of the first embodiment, as shown in FIG. 1C, the LSI chips 11 and 12 are disposed on the substrate 21, wiring is conducted, and the chips are formed in the same package. The memory 3a and the nonvolatile memory 6 are connected to each other by wiring. In the LSI chip 11, for example, the memories 3a and 3b are connected to each other by wiring, so that the memory 3b is also indirectly connected to the nonvolatile memory 6. Instead of the connection to the nonvolatile memory 6 via the wiring in the LSI, the memory 3b can be directly connected to the nonvolatile memory 6.

The memory test circuit 4 has a nonvolatile memory in which a self test program, a repair analysis program, and a software repair program are stored and acts as follows. First, the memory test circuit 4 examines whether or not there is a faulty portion in the memories 3a and 3b by the self test program. When a faulty portion exists, the position of the faulty portion is specified by the repair analysis program. After specifying the position of the faulty portion, information of replacement of the faulty portion with the redundant circuit is stored in the nonvolatile memory 6 by the software repair program.

In the case of using the semiconductor device having such a configuration, when the power is turned on in the semiconductor device, the general logic circuit 2 reads, first, information stored in the nonvolatile memory 6. Since the information regarding the faulty portion of the memories 3a and 3b is stored in the nonvolatile memory 6, the general logic circuit 2 obtains the information. After that, in the case where the general logic circuit 2 uses the memories 3a and 3b in reading/writing operation, the general logic circuit 2 writes/reads data to/from the memories 3a and 3b while replacing the faulty portion in the memories 3a and 3b with a replacement portion in the redundant circuit by referring to the information regarding the faulty portion. In such a manner, the faulty portion in the memories 3a and 3b is replaced with the replacement portion in the redundant circuit, and the resultant memories 3a and 3b are used.

With such a configuration, the fuse conventionally required to repair the conventional memory is replaced with the nonvolatile memory, so that the chip area is reduced, and the improved yield can be achieved. Since the information of replacement of the faulty portion in the memories 3a and 3b with the redundant circuit is stored in the nonvolatile memory 6, the faulty portion can be repaired by software. Specifically, since the faulty portion in the memories 3a and 3b is stored in the nonvolatile memory 6, in the case of using the faulty portion, it is replaced with the redundant circuit by software. As a result, all the faulty portions are repaired, and there is no failure in repair, so that the yield is improved. Further, as a result of eliminating the failure in repair, a test after the repair can be omitted, and the cost of the test can be therefore eliminated. Moreover, since the faulty portion can be repaired by software, unlike the conventional case where the fuse is blown with a laser beam, hardware or a (physical) processing facility is unnecessary, and the cost of the hardware can be also eliminated.

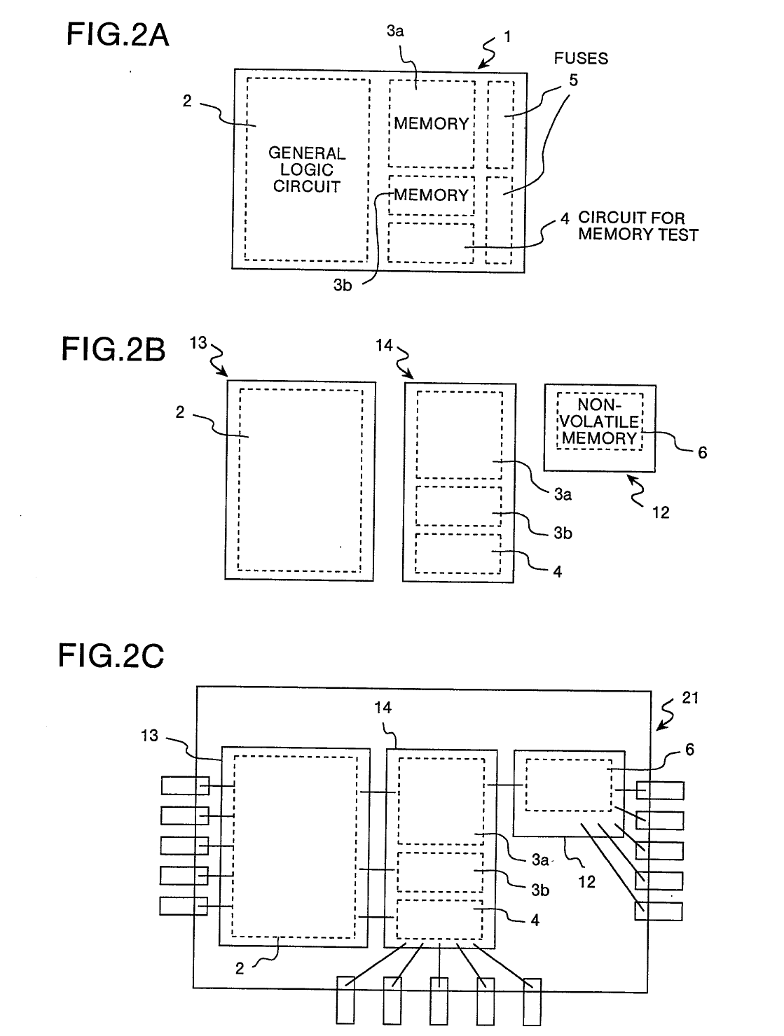

FIGS. 2B and 2C show a second embodiment of the semiconductor device according to the invention, schematically illustrating the difference in the configuration from the conventional semiconductor device. The same reference numerals will be used to designate the same components as those in the first embodiment and their description will not be repeated.

FIG. 2A shows the conventional semiconductor device shown in FIG. 5. In the second embodiment, as shown in FIG. 2B, the general logic circuit 2 portion is fabricated as a general logic LSI chip 13, and the memories 3a and 3b and the memory test circuit 4 are fabricated as a memory LSI chip 14. The general logic LSI chip 13 and the memory LSI chip 14 are manufactured separately. In place of the fuses 5 to be eliminated, the LSI chip 12 for software repair is fabricated separately from the above chips. Further, in the semiconductor device of the second embodiment, as shown in FIG. 2C, the general logic LSI chip 13, memory LSI chip 14, and LSI chip 12 for software repair are mounted on the substrate 21, wiring is conducted, and the chips are formed in the same package. The memories 3a and 3b and the nonvolatile memory 6 are connected to each other by wiring. Although not shown, the memories 3a and 3b and the memory test circuit 4 in the memory LSI chip 14 are connected to each other by wiring. Consequently, the nonvolatile memory 6, memory 3b, and memory test circuit 4 are also electrically connected to each other. The action of the memory test circuit 4 is similar to that of the foregoing first embodiment and its description will not be repeated. As a result of the self test and the repair analysis, the information of replacement of the faulty portion in the memories 3a and 3b with the redundant circuit is stored into the non-volatile memory 6 by a software repair program.

In the case of using the semiconductor device of such a configuration, when the power of the semiconductor is turned on, the general logic circuit 2 first reads the information stored in the nonvolatile memory 6. Since the information regarding the faulty portion in the memories 3a and 3b is stored in the nonvolatile memory 6 as described above, the general logic circuit 2 obtains the information. After that, when the general logic circuit 2 uses the memories 3a and 3b for writing or reading operation, the general logic circuit 2 writes/reads data to/from the memories 3a and 3b while avoiding the faulty portion in the memories 3a and 3b and using the replacement portion in the redundant circuit with reference to the information of the faulty portion. In such a manner, the memories 3a and 3b are used while replacing the faulty portion in the memories 3a and 3b with the replacement portion in the redundant circuit.

With such a configuration, the faulty portion in the memories 3a and 3b can be repaired by software. Since the portion of the memories 3a and 3b and the portion of the memory test circuit 4 are fabricated separately from the general logic circuit 2, even when a memory and logic fabricating process is not used, the LSI chip having therein memories in the same package can be fabricated. The general logic circuit 2 can be fabricated by a cheap logic fabricating process, and the memories 3a and 3b can be similarly fabricated by a cheap memory fabricating process. The total manufacturing cost is lower than that of the conventional memory and logic mounted LCI chip. Since the area of each chip is reduced, the yield is improved, the number of chips mounted on a single wafer increases, and the manufacturing cost can be therefore reduced.

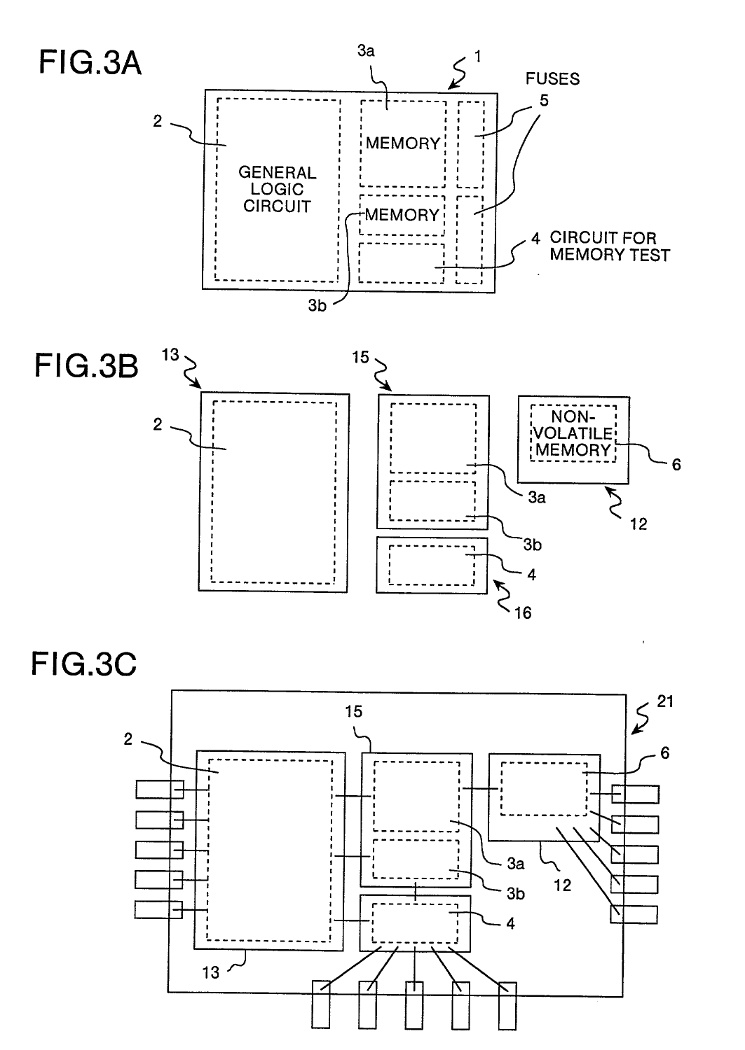

FIGS. 3B and 3C show a third embodiment of the semiconductor device according to the invention and schematically illustrate the difference in the configuration from the conventional semiconductor device so as to be easily understood. The same reference numerals will be used to designate the same components as those in the foregoing first and second embodiments and their description will not be repeated.

FIG. 3A shows the conventional semiconductor device of FIG. 5. In contrast, in the semiconductor device of the third embodiment, as shown in FIG. 3B, the general logic circuit 2 portion is fabricated as a general logic LSI chip 13, the memories 3a and 3b are fabricated as an LSI chip 15 dedicated to memories, and the memory test circuit 4 is formed as a memory test LSI chip 16. The chips are manufactured separately from each other. In place of the fuse 5 eliminated, the LSI chip 12 for software repair on which the nonvolatile memory 6 is mounted is fabricated separately from the above chips. Further, in the semiconductor device of the third embodiment, as shown in FIG. 3C, the general logic LSI chip 13, LSI chip 15 dedicated to memories, LSI chip 16 for memory test, and LSI chip 12 for software repair are mounted on the substrate 21, wiring is conducted, and the chips are formed in the same package. Although the diagram shows that the nonvolatile memory 6 and only the memory 3a are connected to each other, the memories 3a and 3b are also connected to each other by internal wiring of the LSI chip 15 dedicated to memories. Consequently, the memory 3b and the nonvolatile memory 6 are also electrically connected to each other.

The action of the memory test circuit 4 is similar to that of the foregoing first embodiment and its description will not be repeated. As a result of the self test and the repair analysis, the information of replacement of the faulty portion in the memories 3a and 3b with the redundant circuit is stored in the nonvolatile memory 6 by a software repair program. When the power of the semiconductor device is turned on, the general logic circuit 2 first reads the information stored in the nonvolatile memory 6. Since the information regarding the faulty portion in the memories 3a and 3b is stored in the nonvolatile memory 6 as described above, the general logic circuit 2 obtains the information. After that, when the general logic circuit 2 uses the memories 3a and 3b for writing or reading operation, the general logic circuit 2 writes/reads data to/from the memories 3a and 3b while avoiding the faulty portion in the memories 3a and 3b and using the replacement portion in the redundant circuit with reference to the information of the faulty portion. In such a manner, the memories 3a and 3b are used while replacing the faulty portion in the memories 3a and 3b with the replacement portion in the redundant circuit.

With such a configuration, the faulty portion in the memories 3a and 3b can be repaired by software. Since the portion of the memories 3a and 3b and the portion of the memory test circuit 4 are fabricated on the separate chips, the area of the LSI chip 15 dedicated to the memories is reduced, the yield is improved, the number of chips mounted on a single wafer increases, and the manufacturing cost can be therefore reduced. In the conventional memory and logic mounted LSI chip, when the memory test circuit 4 is defective, since the memory test circuit 4 is formed together with the general logic circuit 2 and memories 3a and 3b on one chip, the chip has to be discarded. However, by fabricating the memory test circuit 4 as a discrete chip, when only the memory test circuit 4 is defective, it is sufficient to discard only the memory test circuit 4. Since the other general logic circuit 2 and memories 3a and 3b can be used as they are, the yield is improved. Further, since the memory test circuit 4 is fabricated as the discrete chip, it can be fabricated by a cheap logic fabricating process, and the manufacturing cost can be therefore reduced.

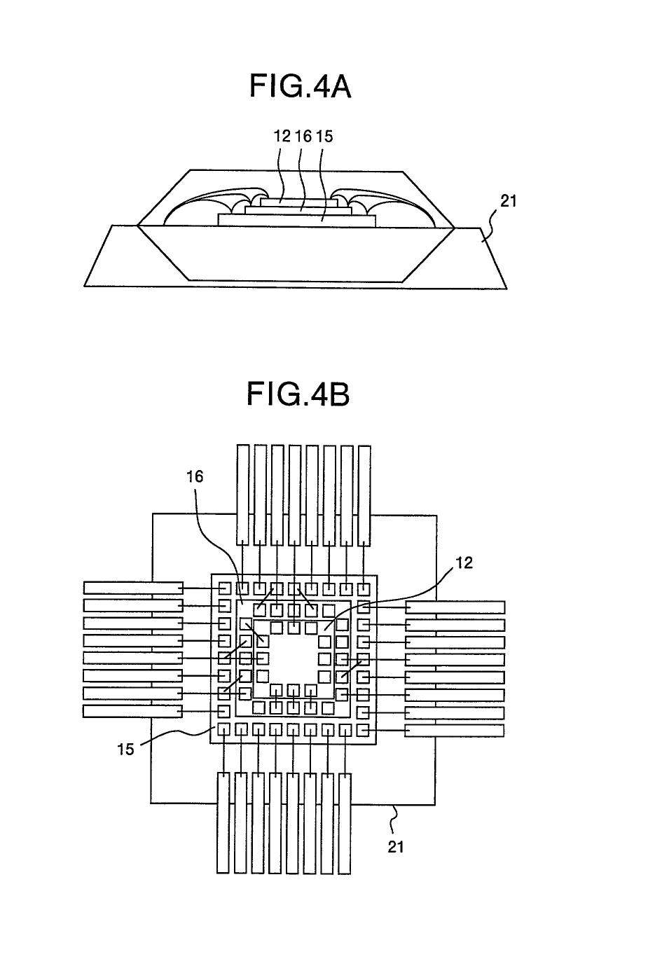

FIGS. 4A and 4B show a fourth embodiment of the semiconductor device according to the invention. FIG. 4A is a side view and FIG. 4B is a plan view of the semiconductor device in which LSI chips are stacked on the substrate 21. The same reference numerals will be used to designate the same components as those in the foregoing first to third embodiments, so that the description will not be repeated.

In the foregoing first to third embodiments, a multi-chip package structure that the LSI chips are arranged flatly on a single substrate is used. In the fourth embodiment, to obtain a multi-chip package structure in which LSI chips are stacked, a memory LSI chip 15 on which only memories are formed, an LSI chip 16 for memory test on which the memory test circuit 4 is formed, and the LSI chip 12 for software repair on which the nonvolatile memory 6 is formed are sequentially stacked on the substrate 21. The LSI chips are connected to each other by wire bonding.

By stacking the LSI chips on the substrate as described above, a smaller semiconductor device can be realized. Although the semiconductor device in which the LSI chips are stacked and connected to each other by wire bonding has been described in the fourth embodiment, the invention can be also applied to a semiconductor device having a configuration that LSI chips are bonded by a method of flip chip bonding, TAB (Tape Automated Bonding), or SiP using a through hole or the like.

In each of the foregoing embodiments, the memory test circuit 4 (LSI chip 12 for software repair in the fourth embodiment) has the self test program for determining whether the memories 3a and 3b (or the memory LSI chip 15) are normal or not, the repair analysis program for specifying a faulty portion by a test conducted by the self test program, and the software repair program for writing information for replacing the faulty portion with a portion in the redundant circuit on the basis of the result of the repair analysis. Usually, these programs are written in the unrewritable nonvolatile memory. However, by using an electrically rewritable nonvolatile memory such as a flash memory instead of the unrewritable nonvolatile memory, the self test program, repair analysis program, or software repair program can be easily changed.

Although each of the foregoing embodiments has been described that each of the memories 3a and 3b (the memory LSI chip 15 in the case of the fourth embodiment) includes the redundant circuit for repair, the redundant circuit can be provided separately from and independently of the memories 3a and 3b (or the memory LSI chip 15). For example, in each of the foregoing first to third embodiments, it is also possible to use 3a as a memory and 3b as a memory for a redundant circuit. In this case, the separated redundant circuit and the memory may be formed on the same chip or on different chips. In such a manner, the packing density of the memory can be increased.

As described above, according to the present invention, faulty portions in the memories can be repaired by software and repair failure does not occur. As a result, the yield is improved, and the process of blowing the fuses with laser beams can be eliminated.

Moreover, a self test can be conducted by the semiconductor device itself to thereby repair a faulty portion in the memory.

Furthermore, even when the circuit for memory test is defective, the whole semiconductor device does not have to be discarded unlike the conventional semiconductor device, but it is sufficient to discard only the circuit for memory test, that is, the third chip. As a result, the area required for providing the memory decreases, the number of chips that can be fabricated on a single wafer increases, and the manufacturing cost can be reduced. In addition, since the parts are formed on separate chips, the semiconductor device can be fabricated by a cheap process.

Moreover, the self test program for determining whether the memory is normal or not, the repair analysis program for specifying the faulty portion, and the software repair program for writing information of replacement of the faulty portion with the redundant circuit into the nonvolatile memory can be easily rewritten. For example, when the self test program, repair analysis program, or software repair program is improved or developed, the whole semiconductor device does not have to be discarded but it is sufficient to rewrite the program in the rewritable nonvolatile memory, so that the resources can be effectively used. A program in an already fabricated semiconductor device can be also rewritten.

According to still another aspect of the invention, the information of replacement of a faulty portion in the memory on the second chip with the redundant circuit on the third chip is stored in the nonvolatile memory on the first chip, and the faulty portion in the memory can be replaced with the redundant circuit on the basis of the information. Consequently, an effect such that all of faulty portions in the memory on the second chip can be repaired by software, no repair failure occurs, and the yield is improved is produced. By the repair with software, the process by hardware such as burning of a fuse with a laser beam as in the conventional technique can be eliminated. In addition, the third chip having the redundant circuit is formed separately from the second chip having the memory, so that the packing density of the memory can be increased.

According to still another aspect of the invention, the second chip having the memory is provided with the circuit for memory test having the nonvolatile memory in which the test program, the repair analysis program, and the software repair program are stored. Consequently, a self test can be conducted by the semiconductor device itself to thereby repair a faulty portion in the memory. All of faulty portions in the memory can be repaired by software, no repair failure occurs, and an effect such that the yield is improved is produced. By the repair with software, the process by hardware such as burning of a fuse with a laser beam as in the conventional technique can be eliminated. In addition, the third chip having the redundant circuit is formed separately from the second chip having the memory, so that the packing density of the memory can be increased.

According to still another aspect of the invention, the fourth chip including the circuit for memory test having the nonvolatile memory in which the test program, repair analysis program, and software repair program are stored is further provided on the substrate. Consequently, even when the circuit for memory test is defective, the whole semiconductor device does not have to be discarded unlike the conventional semiconductor device, but it is sufficient to discard only the circuit for memory test, that is, the fourth chip. Since the area of the memory decreases, effects such that the yield is improved, the number of chips fabricated on a single wafer increases, and the manufacturing cost can be reduced are produced. Further, since the third chip having the redundant circuit is formed separately from the second chip having the memory, the packing density of the memory can be increased.

According to still another aspect of the invention, the nonvolatile memory in the circuit for memory test is rewritable. Consequently, the self test program for determining whether the memory is normal or not, the repair analysis program for specifying a faulty portion, and the software repair program for writing information of a faulty portion with a redundant circuit can be easily rewritten. For example, when the self test program, repair analysis program, or software repair program is improved or developed, the whole semiconductor device does not have to be discarded but it is sufficient to rewrite the program in the rewritable nonvolatile memory, so that the resources can be effectively used. Further, the program in an already fabricated semiconductor device can be rewritten. Moreover, since the third chip having the redundant circuit is formed separately from the second chip having the memory, the packing density of the memory can be increased.

According to still another aspect of the invention, the chips are stacked on the substrate. Thus, the area of the substrate can be reduced, and the size of the whole configuration of the semiconductor device can be reduced.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A semiconductor device comprising:
a first chip having an electrically rewritable nonvolatile memory,
a second chip including a memory having therein a redundant circuit, and
a substrate on which said first chip and second chip are mounted,
wherein information required for utilizing said redundant circuit in place of a faulty portion in said memory on said second chip is stored in said nonvolatile memory on said first chip, and said redundant circuit is utilized in place of the faulty portion in said memory on said second chip based on the information stored in said nonvolatile memory.

2. The semiconductor device according to claim 1, wherein said second chip further comprises a circuit for memory test having a nonvolatile memory, wherein said nonvolatile memory of said second chip stores,
a test program for detecting whether or not there is a faulty portion in said memory on said second chip;
a repair analysis program for identifying the faulty portion when the test program detects that there is a faulty portion in said memory on said second chip, and determining a portion in said redundant circuit that is to be utilized in place of the faulty portion; and
a software repair program for writing information required for utilizing the determined portion in said redundant circuit in place of the faulty portion identified by the repair analysis program in said nonvolatile memory on said first chip.

3. The semiconductor device according to claim 2, wherein said nonvolatile memory in said circuit for memory test is rewritable.

4. The semiconductor device according to claim 1, further comprising a third chip, said third chip being mounted on said substrate, said third chip including a circuit for memory test having a nonvolatile memory, wherein said nonvolatile memory on said third chip stores,
a test program for detecting whether or not there is a faulty portion in said memory on said second chip;
a repair analysis program for identifying the faulty portion when the test program detects that there is a faulty portion in said memory on said second chip, and determining a portion in said redundant circuit that is to be utilized in place of the faulty portion; and
a software repair program for writing information required for utilizing the determined portion in said redundant circuit in place of the faulty portion identified by the repair analysis program in said nonvolatile memory on said first chip.

5. The semiconductor device according to claim 4, wherein said nonvolatile memory in said circuit for memory test is rewritable.

6. The semiconductor device according to claim 1, wherein said first chip and second chip are stacked on said substrate.

7. The semiconductor device according to claim 4, wherein said first chip, said second chip, and third chip are stacked on said substrate.

8. A semiconductor device comprising:
a first chip having an electrically rewritable nonvolatile memory,
a second chip including a memory,
a third chip having a redundant circuit, and
a substrate on which said first chip, said second chip, and said third chip are mounted,
wherein information required for utilizing said redundant circuit on said third chip in place of a faulty portion in said memory on said second chip is stored in said nonvolatile memory on said first chip, and said redundant circuit on said third chip is utilized in place of the faulty portion in said memory on said second chip based on the information stored in said nonvolatile memory on said first chip.

9. The semiconductor device according to claim 5, wherein said second chip further comprises a circuit for memory test having a nonvolatile memory, wherein said nonvolatile memory of said second chip stores,
a test program for detecting whether or not there is a faulty portion in said memory on said second chip;
a repair analysis program for identifying the faulty portion when the test program detects that there is a faulty portion in said memory on said second chip, and determining a position of a portion in said redundant circuit that is to be utilized in place of the faulty portion; and
a software repair program for writing information required for utilizing the determined portion in said redundant circuit in place of the faulty portion identified by the repair analysis program in said nonvolatile memory on said first chip.

10. The semiconductor device according to claim 9, wherein said nonvolatile memory in said circuit for memory test is rewritable.

11. The semiconductor device according to claim 8, further comprising a fourth chip, said fourth chip being mounted on said substrate, said fourth chip including a circuit for memory test having a nonvolatile memory, wherein said nonvolatile memory on said fourth chip stores,
a test program for detecting whether or not there is a faulty portion in said memory on said second chip;
a repair analysis program for identifying the faulty portion when the test program detects that there is a faulty portion in said memory on said second chip, and determining a position of a portion in said redundant circuit that is to be utilized in place of the faulty portion; and
a software repair program for writing information required for utilizing the determined portion in said redundant circuit in place of the faulty portion identified by the repair analysis program in said nonvolatile memory on said first chip.

12. The semiconductor device according to claim 11, wherein said nonvolatile memory in said circuit for memory test is rewritable.

13. The semiconductor device according to claim 8, wherein said first chip, said second chip, and third chip are stacked on said substrate.
